(19) United States
(12) Patent Application Publication
(10) Pub. No.: US 2019/0347355 A1
(43) Pub. Date: Nov. 14, 2019

(54) SYSTEMS AND METHODS FOR CLASSIFYING CONTENT ITEMS BASED ON SOCIAL SIGNALS

(71) Applicant: Facebook, Inc., Menlo Park, CA (US)

(72) Inventors: Ying Zhang, Palo Alto, CA (US); Henry Silverman, Palo Alto, CA (US); Catherine Corinne Dennig, San Francisco, CA (US); Patrick Johannes Caughey, San Francisco, CA (US); Lin Huang, Menlo Park, CA (US)

(21) Appl. No.: 15/978,001

(22) Filed: May 11, 2018

(51) Int. Cl. G06F 17/30; H04L 12/58; G06K 9/62; G06F 15/18

(52) U.S. Cl. CPC G06F 17/30634; H04L 51/32; G06Q 50/01; G06K 9/6256; G06F 15/18; G06F 17/30598

(57) ABSTRACT

Systems, methods, and non-transitory computer readable media can determine an initial classification for a content item based on one or more non-social signals associated with the content item. It can be determined whether to monitor the content item based on the initial classification. A subsequent classification for the content item can be determined based on at least one or more social signals associated with the content item after a determination to monitor the content item.

### FIELD OF THE INVENTION

The present technology relates to the field of social networks. More particularly, the present technology relates to techniques for classifying content items associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

### SUMMARY

Various embodiments of the present technology can include systems, methods, and non-transitory computer readable media configured to determine an initial classification for a content item based on one or more non-social signals associated with the content item. It can be determined whether to monitor the content item based on the initial classification. A subsequent classification for the content item can be determined based on at least one or more social signals associated with the content item after a determination to monitor the content item.

In some embodiments, the one or more non-social signals include one or more of: content attributes or user attributes.

In certain embodiments, a first machine learning model can be trained based on non-social signals associated with a plurality of content items, and the determining the initial classification for the content item is based on the first machine learning model.

In an embodiment, the one or more social signals include one or more of: comments or sentiment reactions.

In some embodiments, a second machine learning model can be trained based on social signals associated with a plurality of content items, and the determining the subsequent classification for the content item is based on the second machine learning model.

In certain embodiments, features for training the second machine learning model include one or more of: comment distribution, reaction distribution, comment content, or sharing distribution.

In an embodiment, the determining whether to monitor the content item based on the initial classification includes determining that a score for the content item associated with the initial classification satisfies a value or a range of values indicating uncertainty regarding whether the content item falls within the initial classification.

In some embodiments, the determining whether to monitor the content item is based on a third machine learning model.

In certain embodiments, the initial classification and the subsequent classification indicate whether the content item is a particular type of content item.

In an embodiment, the determining the subsequent classification for the content item is triggered based on satisfaction of a specified criterion.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content item classification module configured to classify content items, according to an embodiment of the present technology.

FIG. 2A illustrates an example first stage classification module configured to determine initial classifications for content items, according to an embodiment of the present technology.

FIG. 2B illustrates an example second stage classification module configured to determine subsequent classifications for content items, according to an embodiment of the present technology.

FIG. 2C illustrates an example adjustment module configured to adjust rankings for content items, according to an embodiment of the present technology.

FIG. 3A illustrates an example user interface for classifying content items, according to an embodiment of the present technology.

FIG. 3B illustrates an example functional block diagram for classifying content items, according to an embodiment of the present technology.

FIG. 4 illustrates an example first method for classifying content items, according to an embodiment of the present technology.

FIG. 5 illustrates an example second method for classifying content items, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Classifying Content Items Based on Social Signals

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

Conventional approaches specifically arising in the realm of computer technology can classify content items based on various attributes associated with the content items. For example, a content item, such as a post, can be classified based on content of the content item. However, conventional approaches may not take into account social signals or attributes associated with a content item in classifying the content item, such as user comments or user sentiment reactions. Social signals can include information that can be used to more accurately classify a content item. For example, social signals may facilitate identifying a particular type of content item. Accordingly, under conventional approaches, a classification for a content item may not be accurately reflective of the content item.

An improved approach rooted in computer technology can overcome the foregoing and other disadvantages associated with conventional approaches specifically arising in the realm of computer technology. Based on computer technology, the disclosed technology can determine classifications for content items in multiple stages. For example, an initial classification for a content item can be determined based on non-social signals or attributes, and a subsequent classification for the content item can be determined based on social signals or attributes as well as non-social signals or attributes. Non-social signals associated with a content item can include signals other than social signals, such as content attributes and user attributes, and can be available when the content item is created or posted. Social signals associated with a content item can include signals that users provide over time, such as user comments and user reactions, and are generally not available when the content item is created or posted. The initial classification for a content item can be based on a score indicative of whether the content item is a particular type of content item. In some embodiments, a first range of values for the score can indicate that the content item is the particular type, a second range of values for the score can indicate that it is uncertain whether the content item is the particular type, and a third range of values for the score can indicate that the content item is not the particular type. For a content item for which it is uncertain whether the content item is a particular type, the content item can be monitored and classified at a subsequent time based on social signals as well as non-social signals. Initial and/or subsequent classifications for content items can be determined based on machine learning techniques. In this way, the disclosed technology can determine a classification for a content item in multiple stages and incorporate social signals to determine a more accurate classification for the content item. Additional details relating to the disclosed technology are provided below.

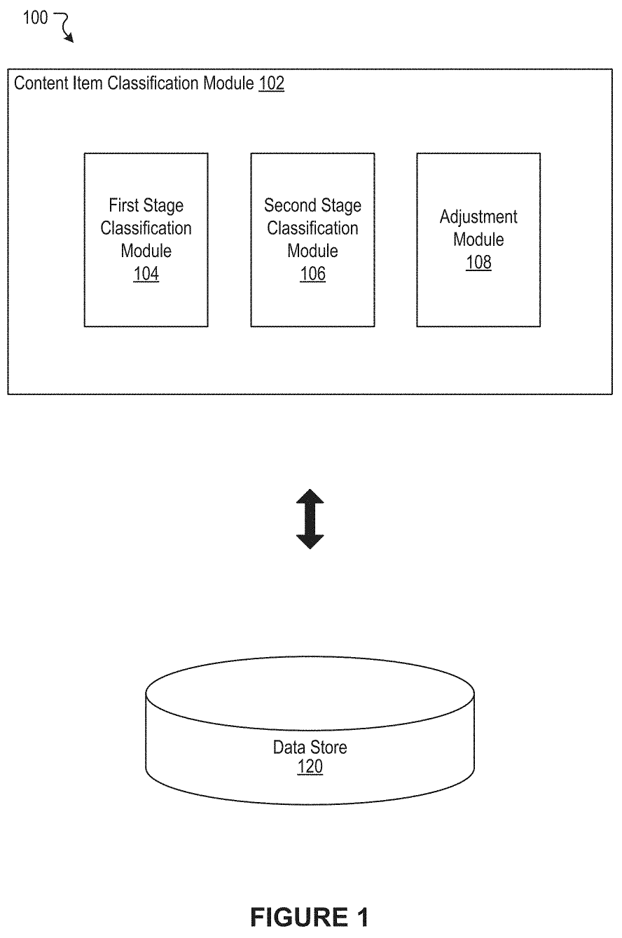

FIG. 1 illustrates an example system 100 including an example content item classification module 102 configured to classify content items, according to an embodiment of the present technology. Content items can include any type of content. Examples of content items can include images, videos, audio, text, etc. Content items can include two-dimensional data, three-dimensional data, etc. Signals or attributes associated with content items can be social or non-social. Social signals associated with a content item can include signals that relate to interactions of users in connection with the content item. For example, social signals can be provided by users over time and are generally not available when the content item is first created or posted. Examples of social signals can include user comments that are created in response to a content item, user sentiment reactions that are selected in response to a content item, etc. Sentiment reactions can also be referred to as “reactions.” Examples of sentiment reactions can include like, happy, sad, angry, surprise, etc. Non-social signals associated with a content item can include signals other than social signals. Non-social signals can be available when the content item is created or posted. Examples of non-social signals can include content attributes, user attributes, etc. For example, user attributes can include attributes associated with a user that creates a content item. In some embodiments, a content item can be included in a post, and a user can create a comment and/or select a sentiment reaction in response to the post. A content item and an associated comment or sentiment reaction can each be represented in a social graph and related to each other in the social graph. A social graph can include entities or objects and can reflect relationships, interactions, affinities, etc. among the entities or objects. For example, a social graph can include content items and reflect relationships among content items, between content items and comments, between content items and sentiment reactions, etc.

The content item classification module 102 can classify a content item and determine whether the content item is of a particular type. For example, a classification can be associated with a particular type of content item. The content item classification module 102 can make an initial determination of whether the content item falls within the classification. The initial determination can be based on non-social signals associated with the content item. If it is uncertain whether the content item falls within the classification based on the initial determination, the content item classification module 102 can monitor the content item and make a subsequent determination of whether the content item falls within the classification. The subsequent determination can be based on social signals associated with the content item and/or non-social signals associated with the content item. As discussed herein, a process of making an initial determination and one or more subsequent determinations of whether a content item falls within a classification can be referred to as a “multi-stage classification process.”

If a content item is determined to be a particular type, one or more actions may be taken in connection with the content item. In some embodiments, rankings of particular types of content items may be adjusted, for example, for inclusion in a feed of a user. Examples of such types of content items can include engagement bait, click bait, etc. These types of content items may attempt to artificially increase user interaction with the content items, for example, by soliciting responses or actions from users. As discussed herein, “engagement bait” may indicate a content item that attempts to influence users to engage with the content item in a way that is not typical or not desired. For instance, engagement bait can include a poll, a sweepstake, a contest, etc. As an example, engagement bait may include a question and ask a user to respond with different letters (e.g., “A,” “B,” “C,” etc.) to the question. As discussed herein, “click bait” may indicate a content item that attempts to entice users to click on the content item or a link included in the content item. For instance, click bait can withhold information to entice a user to click or select a content item or a link included in a content item to obtain the withheld information. Content items may be selected for inclusion in a feed of a user of social networking system based on rankings that account for social signals associated with the content items. Accordingly, in some instances, types of content items, such as engagement bait and click bait, may be undesirably ranked highly for inclusion in a feed of a user due to a significant amount of user comments or user reactions. The content item classification module 102 can adjust rankings for these types of content items to be lower so that the content items are demoted in a selection process for inclusion in a feed.

In this manner, the present technology can determine a classification for a content item based on a multi-stage classification process. The present technology can determine a more accurate classification for a content item based on social signals as the social signals become available over time. In addition, the present technology can take one or more actions based on the classification of a content item determined based on social signals.

The content item classification module 102 can include a first stage classification module 104, a second stage classification module 106, and an adjustment module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the content item classification module 102 can be implemented in any suitable combinations. While the disclosed technology is described in connection with content items associated with a social networking system for illustrative purposes, the disclosed technology can apply to any other type of system and/or content.

The first stage classification module 104 can determine an initial classification for a content item based on non-social signals associated with the content item. The first stage classification module 104 determine whether to monitor the content item to determine a subsequent classification for the content item. The first stage classification module 104 can determine the initial classification and whether to monitor the content item based on machine learning techniques. Functionality of the first stage classification module 104 is described in more detail herein.

The second stage classification module 106 can determine a subsequent classification for a monitored content item based on social signals associated with the content item and/or non-social signals associated with the content item. The second stage classification module 106 can determine the subsequent classification based on machine learning techniques. Functionality of the second stage classification module 106 is described in more detail herein.

The adjustment module 108 can adjust a ranking for a content item based on the classification for the content item. For example, the ranking for the content item can be decreased or otherwise adjusted upon a determination that the content item is, for example, engagement bait or click bait. Functionality of the adjustment module 108 is described in more detail herein.

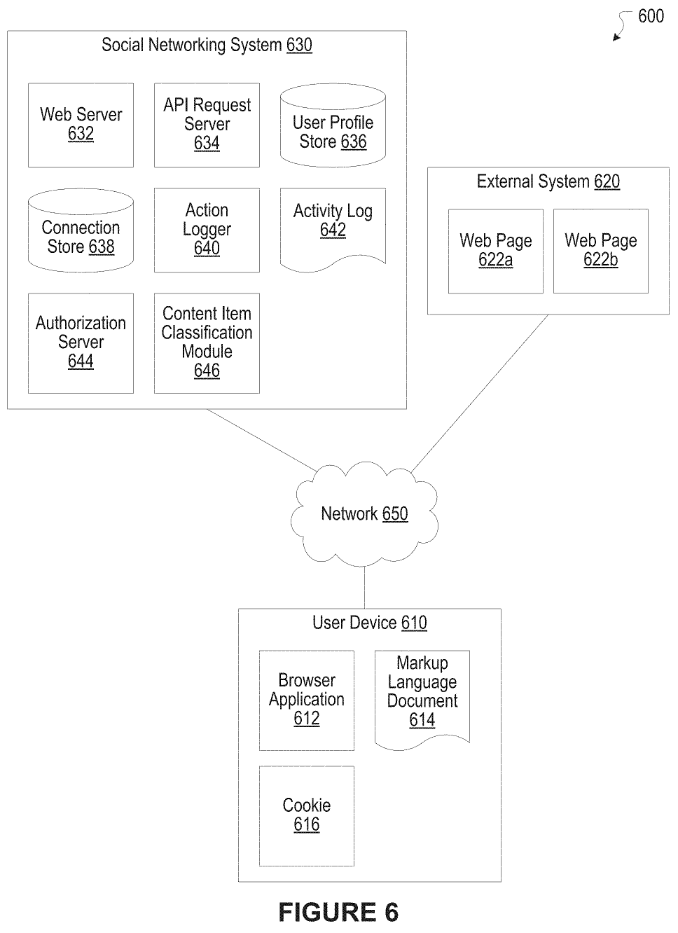

In some embodiments, the content item classification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content item classification module 102 can be, in part or in whole, implemented as software running on one or more computing devices or systems, such as on a server system or a client computing device. In some instances, the content item classification module 102 can be, in part or in whole, implemented within or configured to operate in conjunction or be integrated with a social networking system (or service), such as a social networking system 630 of FIG. 6. Likewise, in some instances, the content item classification module 102 can be, in part or in whole, implemented within or configured to operate in conjunction or be integrated with a client computing device, such as the user device 610 of FIG. 6. For example, the content item classification module 102 can be implemented as or within a dedicated application (e.g., app), a program, or an applet running on a user computing device or client computing system. The application incorporating or implementing instructions for performing functionality of the content item classification module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the content item classification module 102. The data maintained by the data store 120 can include, for example, information relating to content items, classifications, social signals, non-social signals, machine learning models, rankings, adjustment of rankings, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content item classification module 102 can be configured to communicate and/or operate with the data store 120. In some embodiments, the data store 120 can be a data store within a client computing device. In some embodiments, the data store 120 can be a data store of a server system in communication with the client computing device.

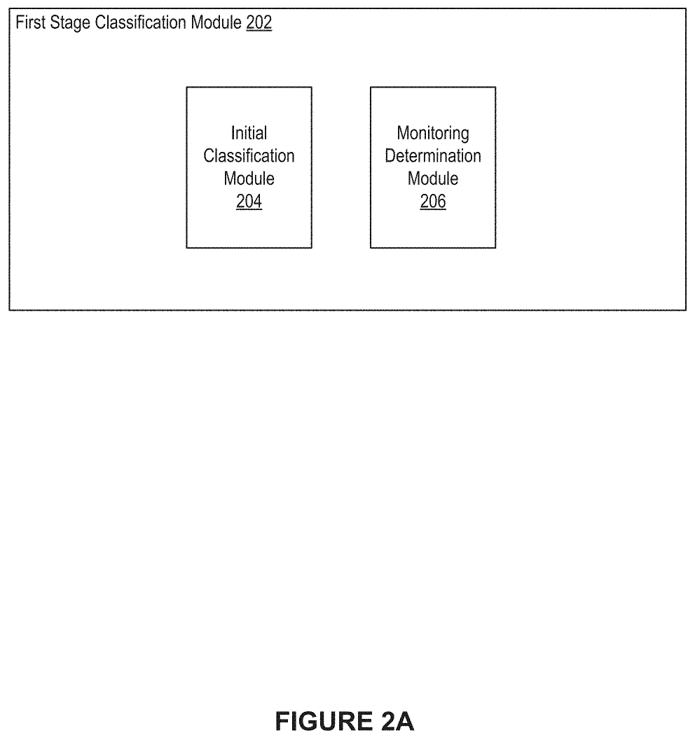

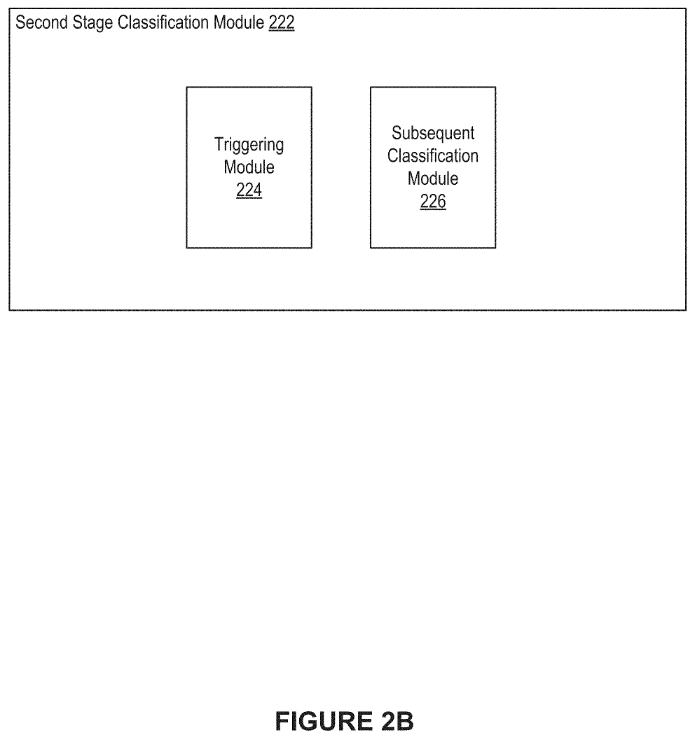

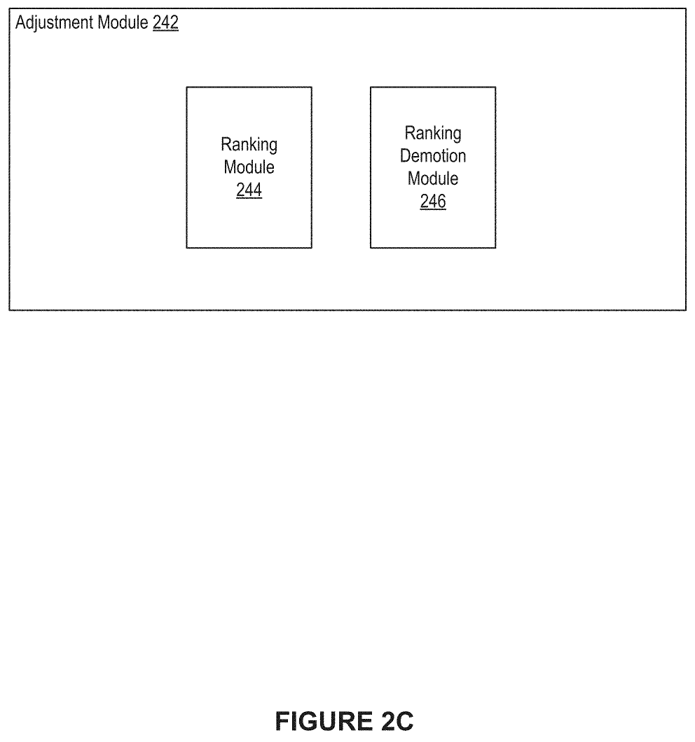

FIG. 2A illustrates an example first stage classification module 202 configured to determine initial classifications for content items, according to an embodiment of the present technology. In some embodiments, the first stage classification module 104 of FIG. 1 can be implemented with the example first stage classification module 202. As shown in the example of FIG. 2A, the example first stage classification module 202 can include an initial classification module 204 and a monitoring determination module 206.

The initial classification module 204 can determine an initial classification for a content item based on non-social signals associated with the content item. The initial classification module 204 can train a machine learning model to determine whether a content item is a particular type of content item. As an example, the particular type of content item can be engagement bait or click bait. Training data (e.g., labeled data) for training the machine learning model can include information relating to content items, non-social signals associated with the content items, classifications for the content items, etc. For example, the classification for a content item in the training data can indicate whether the content item is the particular type or not. The training data can include various features. For example, features can relate to non-social signals, such as content attributes associated with content items, user attributes, etc. Content attributes can relate to a content item and can include any attributes associated with content of a content item. Examples of content attributes can include text, an image, a video, an audio, a type of media (e.g., an image, a video, an audio, text, etc.), a duration of a content item (e.g., time length of a video), a subject matter, one or more objects represented in a content item, etc. User attributes can include any attributes associated with users. For instance, user attributes can include user attributes associated with authoring users of content items. An authoring user can refer to a user who creates a content item. Examples of user attributes relating to an authoring user can include a location (e.g., a country, state, county, city, etc.), an age, an age range, a gender, a language, interests (e.g., topics in which the user has expressed interest), a computing device, an operating system (OS) of a computing device, historical activities or patterns, etc. Historical activities or patterns of a user can include whether the user has created content items of the particular type in the past. Many variations are possible. The initial classification module 204 can retrain the machine learning model based on new or updated training data.

The initial classification module 204 can apply the trained machine learning model to determine classifications for content items. For example, the trained machine learning model can be applied to feature data relating to a content item to determine a classification for the content item. For example, the initial classification module 204 can train the machine learning model to generate a score for a classification. The score associated with a classification can reflect a predicted likelihood that a content item falls within the classification. As an example, the classification can be engagement bait, and an associated score can reflect a predicted likelihood that the content item is engagement bait. Likewise, the classification can be click bait, and an associated score can reflect a predicted likelihood that the content item is click bait. In some instances, the initial classification module 204 can determine a content item to fall within the classification if the score for the classification for the content item satisfies a threshold value. In some instances, the initial classification module 204 can determine a content item to not fall within the classification if the score for the classification for the content item does not satisfy a threshold value. In some embodiments, the initial classification module 204 can train a machine learning model to determine scores for a plurality of classifications.

The monitoring determination module 206 can determine whether to monitor a content item to determine a subsequent classification for the content item. For example, the monitoring determination module 206 can determine a value or a range of values of a score for the classification for a content item that should be monitored for subsequent classification. A score for the classification of a content item can be determined by the initial classification module 204, as described above. In some embodiments, the monitoring determination module 206 can determine a first value or range of values of scores that indicates that a content item falls within the classification, a second value or range of values of scores that indicates it is uncertain whether a content item falls within the classification, and a third value or range of values of scores that indicates that a content item does not fall within the classification. For example, the monitoring determination module 206 can determine that a content item with a score having the second value or a value within the second range of values should be monitored for subsequent classification based on social signals. As discussed herein, the first value or range of values, the second value or range of values, and the third value or range of values can also be referred to as the first bucket, the second bucket, and the third bucket, respectively. The monitoring determination module 206 can associate one or more triggers with a content item to be monitored such that a subsequent classification can be determined for the content item when specified criteria is satisfied.

The monitoring determination module 206 can train a machine learning model to determine a value or a range of values of scores associated with monitoring content items for subsequent classification. For example, the monitoring determination module 206 can train the machine learning model to determine the first bucket, the second bucket, and the third bucket. The monitoring determination module 206 can train the machine learning model to generate a first value or range of values that indicates a content item falls within the classification, a second value or range of values that indicates it is uncertain whether a content item falls within the classification, and a third value or range of values that indicates a content item does not fall within the classification. Training data (e.g., labeled data) for training the machine learning model can include information relating to content items, non-social signals associated with the content items, scores for the classification for the content items, the classification for the content items, etc. For example, the classification for a content item in the training data can indicate whether the content item is the particular type or not. The training data can include various features. Features can be similar to the features discussed in connection with the initial classification module 204. As an example, the machine learning model can be trained based on user attributes, such as historical activities or patterns of users. The monitoring determination module 206 can retrain the machine learning model based on new or updated training data.

The monitoring determination module 206 can apply the trained machine learning model to determine whether to monitor a content item. For example, the trained machine learning model can be applied to feature data relating to a content item to determine whether to monitor the content item. The score for the classification of the content item can be provided as an input to the machine learning model, and the machine learning model can provide as an output whether the content item falls within the classification, whether the content item does not fall within the classification, or whether the content item requires monitoring.

In some embodiments, machine learning models trained by the initial classification module 204 and the monitoring determination module 206 can be implemented as separate machine learning models. In other embodiments, machine learning models trained by the initial classification module 204 and the monitoring determination module 206 can be implemented as a single machine learning model. As discussed herein, a machine learning model trained by the first stage classification module 202 can be referred to as a “first stage machine learning model.” One or more machine learning models discussed in connection with the content item classification module 102 and its components, such as the first stage classification module 202 and a second stage classification module 222 as discussed below, can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

FIG. 2B illustrates an example second stage classification module 222 configured to determine subsequent classifications for content items, according to an embodiment of the present technology. In some embodiments, the second stage classification module 106 of FIG. 1 can be implemented with the example second stage classification module 222. As shown in the example of FIG. 2B, the example second stage classification module 222 can include a triggering module 224 and a subsequent classification module 226.

The triggering module 224 can trigger determination of a subsequent classification for a content item that is monitored. For example, the monitoring determination module 206 can have determined that the content item should be monitored. The triggering module 224 can trigger determining the subsequent classification for the content item based on specified criteria. Examples of specified criteria can include edits to content of a content item, changes in a social graph in connection with a content item, a number of views of a content item satisfying a threshold value, etc. Edits to content of a content item can include any changes to text, visual content, audio content, etc. of the content item. Changes in a social graph in connection with a content item can include any changes relating to the content item in the social graph, such as creation of new comments, new sentiment reactions, etc. For instance, each comment or sentiment reaction can be represented as an entity or a node in the social graph, and a new comment or sentiment reaction can be represented as a new entity or a new node in the social graph. In some embodiments, specified criteria can include a threshold value that should be satisfied by changes in a social graph before subsequent classification of a content item. As an example, a specified criterion can be satisfaction of a threshold value relating to a predetermined number of new comments associated with a content item in order to trigger determination of a subsequent classification of the content item. As another example, a specified criterion can be satisfaction of a threshold value relating to a predetermined number of new sentiment reactions associated with the content item in order to trigger determination of a subsequent classification of a content item. In some embodiments, specified criteria can also include satisfaction of a threshold value relating to a predetermined number of views of a content item before a subsequent classification is determined for the content item. In some embodiments, a number of views of a content item can also be referred to as a number of viewport views.

The subsequent classification module 226 can determine a subsequent classification for a monitored content item based on social signals associated with the content item and/or non-social signals associated with the content item. For example, the subsequent classification module 226 can determine the subsequent classification when the subsequent classification is triggered by the triggering module 224 based on specified criteria. The subsequent classification module 226 can determine a subsequent classification for a content item one or more times, as appropriate. For example, a subsequent classification for a content item can be determined periodically over time, for example, each time a subsequent classification is triggered based on specified criteria.

The subsequent classification module 226 can train a machine learning model to determine whether a content item is a particular type of content item. As an example, the particular type of content item can be engagement bait. As another example, the particular type of content item can be click bait. Training data (e.g., labeled data) for training the machine learning model can include information relating to content items, social signals associated with the content items, non-social signals associated with the content items, classifications for the content items, etc. For example, the classification for a content item in the training data can indicate whether the content item is the particular type or not. The training data can include various features. For example, features can relate to social signals, non-social signals, etc. Non-social signals can be similar to non-social signals described above in connection with the first stage classification module 202. For example, non-social signals can include content attributes, user attributes, etc. Social signals can include comments, sentiment reactions, etc.

Examples of features relating to social signals can include comment distribution, reaction distribution, comment content, sharing distribution, etc. As described above, content items can be ranked for inclusion in a feed of a user, and rankings for content items of particular types may need to be adjusted. As discussed herein, content items for which rankings do not need to be adjusted can be referred to as “typical content items.” Comment distribution can indicate a distribution of comments reflecting user sentiment associated with a content item. For a typical content item, the distribution of comments reflecting user sentiment generally tends to be similar. For example, the distribution of comments is either generally positive sentiment or generally negative sentiment. However, for a content item for which the ranking should be adjusted, such as engagement bait or click bait, the distribution of comments generally tends to be uniform. For example, if the content item is engagement bait, the content item can include a question requesting users to respond with particular letters or numbers corresponding to different options. Accordingly, the distribution of comments may be generally uniform or evenly distributed across the letters or numbers. In some cases, the distribution of comments for a content item for which the ranking should be adjusted may not be uniform, but may deviate from the distribution of comments for a typical content item. Such distribution of comments may be considered to be an abnormal distribution. An abnormal distribution of comments can be indicative of a content item for which the ranking should be adjusted, such as engagement bait or click bait. An abnormal distribution can refer to a distribution that deviates from a typical or usual distribution by a threshold value or extent. Reaction distribution can indicate a distribution of reactions associated with a content item. Similar to comment distribution, for a typical content item, the distribution of reactions generally tends to be similar. For example, the distribution of reactions is either generally positive (e.g., like) or generally negative (e.g., dislike). However, for a content item for which the ranking should be adjusted, such as engagement bait or click bait, the distribution of reactions can tend to be uniform or abnormal. Such uniform or abnormal distribution of reactions can be indicative of a content item for which the ranking should be adjusted. Comment content can indicate whether a comment includes tagging or referencing of one or more users or entities, includes a repeated set of letters or numbers, includes phone numbers, etc. For example, a comment including tags, a repeated set of letters or numbers, or phone numbers can be indicative of a poll, a sweepstake, a contest, etc. Sharing distribution can indicate a distribution of sharing of a content item. For a content item for which the ranking should be adjusted, sharing behavior may be different or abnormal compared to sharing behavior for a typical content item. For example, a content item for which the ranking should be adjusted may be associated with a ratio of sharing that is higher than a ratio of sharing for a typical content item. In this regard, users may be sharing a content item without viewing the content item or a link included in the content item. Such abnormal distribution of sharing may be indicative of a content item for which the ranking should be adjusted. Many variations are possible. The subsequent classification module 226 can retrain the machine learning model based on new or updated training data.

The subsequent classification module 226 can apply the trained machine learning model to determine classifications for content items. For example, the trained machine learning model can be applied to feature data relating to a content item to determine a classification for the content item. For example, the subsequent classification module 226 can train the machine learning model to generate a score for a classification. The score associated with a classification can reflect a predicted likelihood that a content item falls within the classification. As an example, the classification can be engagement bait, and the score can reflect a predicted likelihood that the content item is engagement bait. As another example, the classification can be click bait, and the score can reflect a predicted likelihood that the content item is click bait. In some instances, the subsequent classification module 226 can determine a content item to fall within the classification if the score for the classification for the content item satisfies a threshold value. In some instances, the subsequent classification module 226 can determine a content item to not fall within the classification if the score for the classification for the content item does not satisfy a threshold value. In some embodiments, the subsequent classification module 226 can train a machine learning model to determine scores for a plurality of classifications.

In some embodiments, the subsequent classification module 226 can train a separate machine learning model for each type of content item. For example, the subsequent classification module 226 can train a machine learning model for engagement bait and another machine learning model for click bait. The machine learning model for a particular type of content item can be trained based on features that are relevant for that type of content item. Social signals relevant to click bait can include landing page behavior. For example, when a user clicks on or selects a link included in click bait, a landing page can be displayed to the user. For example, for click bait, features for training the machine learning model can include landing page time distribution. Landing page time distribution can indicate a distribution of an amount of time spent associated with a landing page of a link included in a content item. For example, for a content item for which the ranking should be adjusted, the distribution of the amount of time spent may be a fraction of or abnormal compared to the distribution of the amount of time spent for a typical content item. As discussed herein, a machine learning model trained by the second stage classification module 222 can be referred to as a “second stage machine learning model.” All examples herein are provided for illustrative purposes, and there can be many variations and other possibilities.

FIG. 2C illustrates an example adjustment module 242 configured to adjust rankings for content items, according to an embodiment of the present technology. In some embodiments, the adjustment module 108 of FIG. 1 can be implemented with the example adjustment module 242. As shown in the example of FIG. 2C, the example adjustment module 242 can include a ranking module 244 and a ranking demotion module 246.

The ranking module 244 can rank content items, for example, for inclusion in a feed of a user. The ranking module 244 can rank content items based on various factors. Examples of factors can include a probability of liking a content item, a probability of commenting on a content item, a probability of sharing a content item, etc. Many variations are possible. The ranking module 244 can generate a score for a content item, and content items can be ranked or ordered based on their respective scores.

The ranking demotion module 246 can decrease or otherwise adjust the ranking of a content item. For example, the ranking demotion module 246 can demote the ranking of a content item. In some embodiments, the demotion of the ranking of the content item can be additive. For instance, various factors used in ranking of the content item can be added and can be used to demote the ranking of the content item. In other embodiments, the demotion of the ranking of the content item can be multiplicative. For instance, various factors used in ranking of the content item can be multiplied and can be used to demote the ranking of the content item. As an example, the various factors used to determine the ranking of the content item can be added or multiplied to determine a relevance term, and the ranking of the content item can be demoted by the relevance term. In some embodiments, the ranking demotion module 246 can demote the ranking of engagement bait or click bait. As an example, if a content item is classified as engagement bait, the ranking of the content item can be demoted in order to reduce potentially undesirable content, for example, in a feed of a user. As another example, if a content item is classified as click bait, the ranking of the content item can be demoted in order to reduce potentially undesirable content, for example, in a feed of a user. For illustrative purposes, adjustment of ranking is described as an example of an action that can be taken in connection with content items that have been determined to fall within a classification according to a multi-stage classification process, but other actions can be taken as well. All examples herein are provided for illustrative purposes, and there can be many variations and other possibilities.

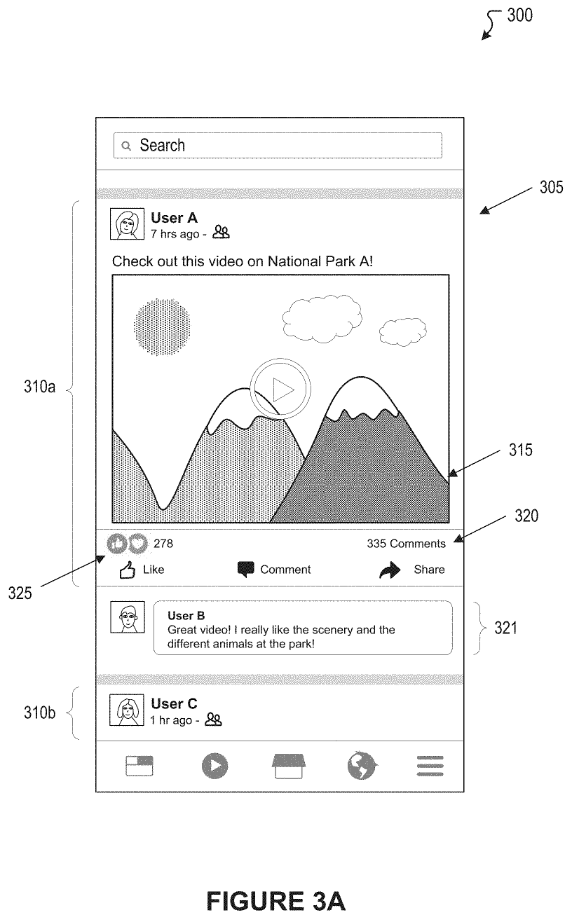

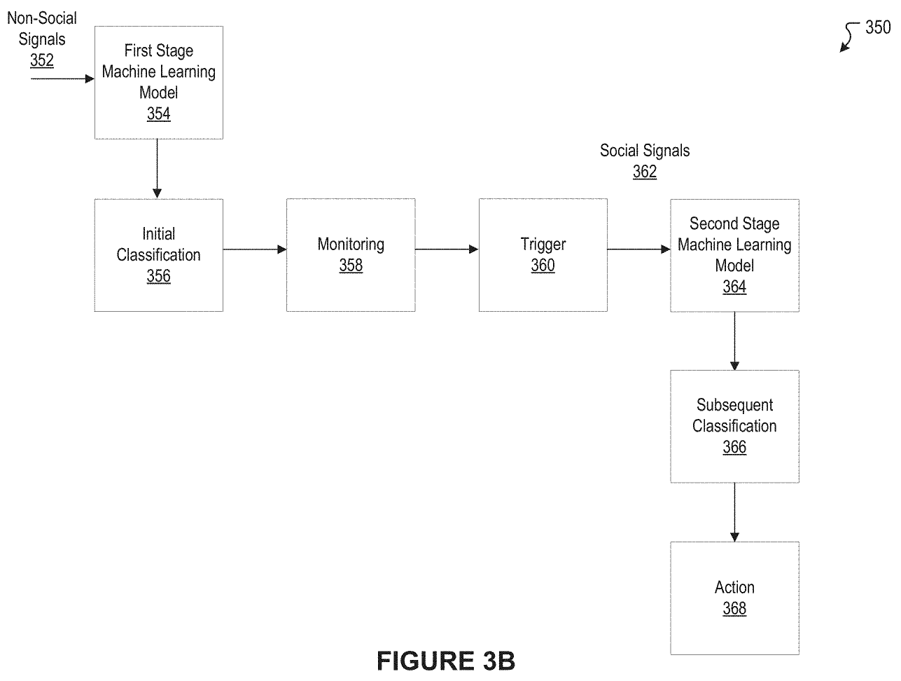

FIG. 3A illustrates an example user interface 300 for classifying content items, according to an embodiment of the present technology. The user interface 300 shows a feed 305 of a user. The feed 305 includes a post 310a and a post 310b. The post 310a includes a content item 315. In the example of FIG. 3A, the content item 315 is a video. A user may create a comment in response to the post 310a or the content item 315. In the example of FIG. 3A, a total of 335 comments 320 have been created for the content item 315, including a comment 321 that is shown in the feed 305. The comment 320 includes text information, including various words (e.g., “Great video! I really like the scenery and the different animals at the park!”). A user may also select a sentiment reaction in response to the post 310a or the content item 315. In the example of FIG. 3A, a total 278 sentiment reactions 325 have been selected or created for the content item 315. Non-social signals associated with the content item 315 can include content attributes, user attributes, etc. associated with the content item 315. For example, content attributes can include attributes associated with content of the video. Non-social signals associated with content items can be used to determine initial classifications for the content items. Social signals associated with the content item 315 can include the comments 320 and the sentiment reactions 325. Social signals associated with content items can be used to determine subsequent classifications for the content items. The initial classifications and subsequent classifications of content items can be determined by the content item classification module 102, as discussed herein. All examples herein are provided for illustrative purposes, and there can be many variations and other possibilities.

FIG. 3B illustrates an example functional block diagram 350 for classifying content items, according to an embodiment of the present technology. Operations and functionalities associated with the functional block diagram 350 can be performed by the content item classification module 102, as discussed herein. For example, the initial classifications and subsequent classifications of content items can be determined by the content item classification module 102, as discussed herein. Non-social signals 352 associated with a content item, along with other feature data associated with the content item, can be provided to a first stage machine learning model 354. The first stage machine learning model 354 can be a machine learning model trained based on non-social signals associated with content items and/or other signals. The first stage machine learning model 354 can determine an initial classification 356 for the content item based on the non-social signals 352 and/or other feature data. At block 358, if the initial classification 356 for the content item cannot be determined with a threshold level of certainty, the content item can be monitored to determine a subsequent classification for the content item at a later time. At block 360, if specified criteria is satisfied, determining a subsequent classification for the content item can be triggered. If determination of a subsequent classification for the content item is triggered, social signals 362 associated with the content item, along with other feature data associated with the content item, can be provided to a second stage machine learning model 364. The second stage machine learning model 364 can be a machine learning model trained based on social signals associated with content items as well as other signals, such as non-social signals associated with the content items. The second stage machine learning model 364 can determine a subsequent classification 366 for the content item based on the social signals 362 and/or other feature data. At block 368, an appropriate action can be taken in connection with the content item based on the subsequent classification 366. In some embodiments, an action can be taken in connection with detection of engagement bait or click bait. For example, if a content item is determined to be engagement bait or click bait, a ranking of the content item can be adjusted. In some embodiments, a ranking of a content item can be demoted as a way to moderate presence of potentially undesirable content in a feed of a user or in a social networking system. All examples herein are provided for illustrative purposes, and there can be many variations and other possibilities.

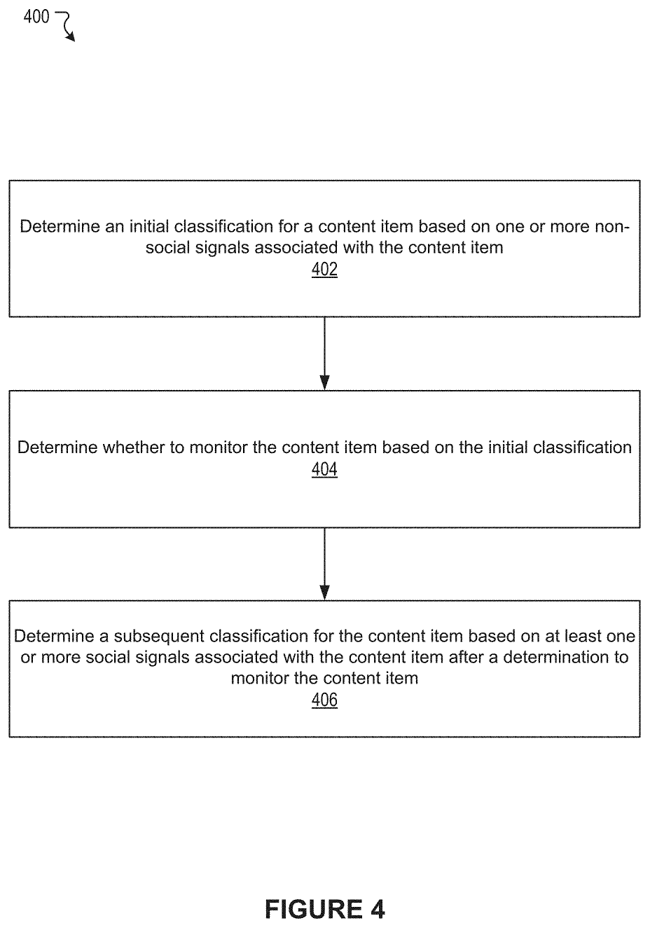

FIG. 4 illustrates an example first method 400 for classifying content items, according to an embodiment of the present technology. It should be understood that there can be additional, fewer, or alternative steps performed in similar or alternative orders, or in parallel, based on the various features and embodiments discussed herein unless otherwise stated.

At block 402, the example method 400 can determine an initial classification for a content item based on one or more non-social signals associated with the content item. At block 404, the example method 400 can determine whether to monitor the content item based on the initial classification. At block 406, the example method 400 can determine a subsequent classification for the content item based on at least one or more social signals associated with the content item after a determination to monitor the content item. Other suitable techniques that incorporate various features and embodiments of the present technology are possible.

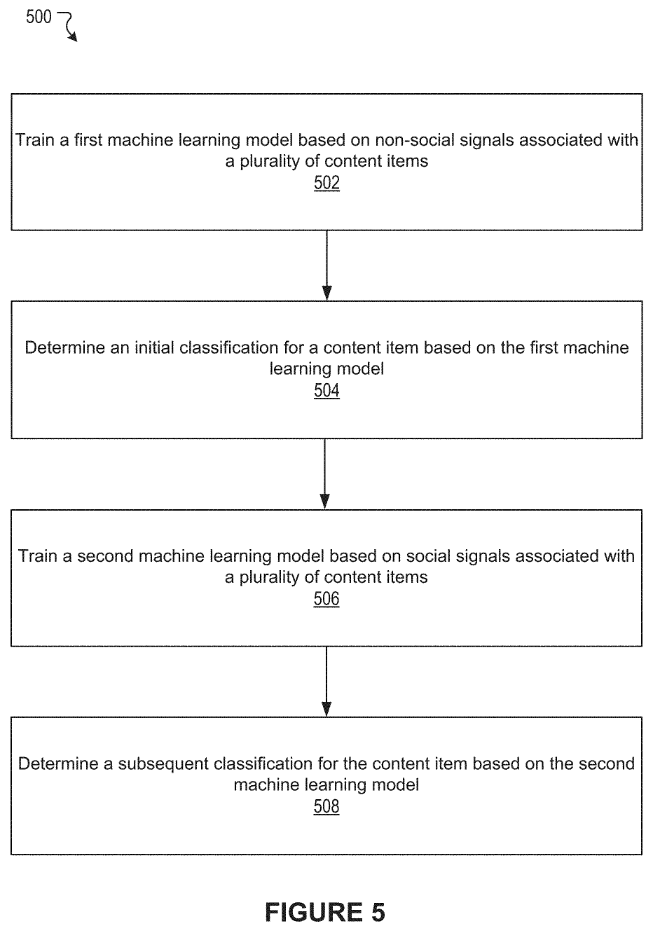

FIG. 5 illustrates an example second method 500 for classifying content items, according to an embodiment of the present technology. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a first machine learning model based on non-social signals associated with a plurality of content items. At block 504, the example method 500 can determine an initial classification for a content item based on the first machine learning model. At block 506, the example method 500 can train a second machine learning model based on social signals associated with a plurality of content items. At block 508, the example method 500 can determine a subsequent classification for the content item based on the second machine learning model. Other suitable techniques that incorporate various features and embodiments of the present technology are possible.

It is contemplated that there can be many other uses, applications, features, possibilities, and/or variations associated with various embodiments of the present technology. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content item classification module 646. The content item classification module 646 can be implemented with the content item classification module 102, as discussed in more detail herein. In some embodiments, one or more functionalities of the content item classification module 646 can be implemented in the user device 610.

### Hardware Implementation

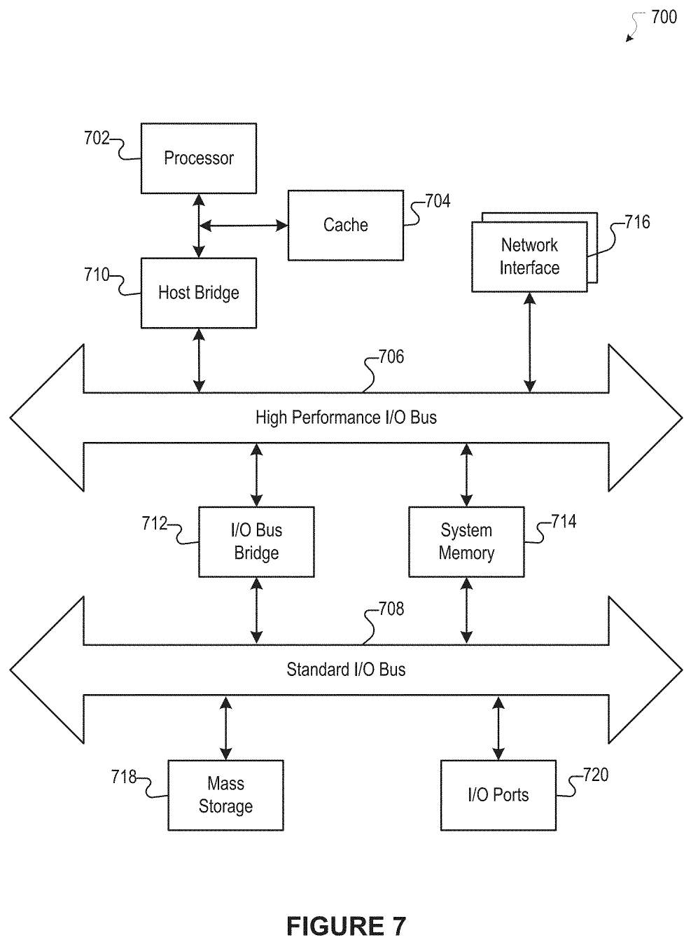

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, an initial classification for a content item based on one or more non-social signals associated with the content item;
determining, by the computing system, whether to monitor the content item based on the initial classification; and
determining, by the computing system, a subsequent classification for the content item based on at least one or more social signals associated with the content item after a determination to monitor the content item.

2. The computer-implemented method of claim 1, wherein the one or more non-social signals include one or more of: content attributes or user attributes.

3. The computer-implemented method of claim 1, further comprising training a first machine learning model based on non-social signals associated with a plurality of content items, and wherein the determining the initial classification for the content item is based on the first machine learning model.

4. The computer-implemented method of claim 1, wherein the one or more social signals include one or more of: comments or sentiment reactions.

5. The computer-implemented method of claim 1, further comprising training a second machine learning model based on social signals associated with a plurality of content items, and wherein the determining the subsequent classification for the content item is based on the second machine learning model.

6. The computer-implemented method of claim 5, wherein features for training the second machine learning model include one or more of: comment distribution, reaction distribution, comment content, or sharing distribution.

7. The computer-implemented method of claim 1, wherein the determining whether to monitor the content item based on the initial classification includes determining that a score for the content item associated with the initial classification satisfies a value or a range of values indicating uncertainty regarding whether the content item falls within the initial classification.

8. The computer-implemented method of claim 7, wherein the determining whether to monitor the content item is based on a third machine learning model.

9. The computer-implemented method of claim 1, wherein the initial classification and the subsequent classification indicate whether the content item is a particular type of content item.

10. The computer-implemented method of claim 1, wherein the determining the subsequent classification for the content item is triggered based on satisfaction of a specified criterion.

11. A system comprising:
at least one hardware processor; and
a memory storing instructions that, when executed by the at least one processor, cause the system to perform:
determining an initial classification for a content item based on one or more non-social signals associated with the content item;
determining whether to monitor the content item based on the initial classification; and
determining a subsequent classification for the content item based on at least one or more social signals associated with the content item after a determination to monitor the content item.

12. The system of claim 11, wherein the one or more non-social signals include one or more of: content attributes or user attributes.

13. The system of claim 11, wherein the instructions further cause the system to perform training a first machine learning model based on non-social signals associated with a plurality of content items, and wherein the determining the initial classification for the content item is based on the first machine learning model.

14. The system of claim 11, wherein the one or more social signals include one or more of: comments or sentiment reactions.

15. The system of claim 11, wherein the instructions further cause the system to perform training a second machine learning model based on social signals associated with a plurality of content items, and wherein the determining the subsequent classification for the content item is based on the second machine learning model.

16. A non-transitory computer readable medium including instructions that, when executed by at least one hardware processor of a computing system, cause the computing system to perform a method comprising:
determining an initial classification for a content item based on one or more non-social signals associated with the content item;
determining whether to monitor the content item based on the initial classification; and
determining a subsequent classification for the content item based on at least one or more social signals associated with the content item after a determination to monitor the content item.

17. The non-transitory computer readable medium of claim 16, wherein the one or more non-social signals include one or more of: content attributes or user attributes.

18. The non-transitory computer readable medium of claim 16, wherein the method further comprises training a first machine learning model based on non-social signals associated with a plurality of content items, and wherein the determining the initial classification for the content item is based on the first machine learning model.

19. The non-transitory computer readable medium of claim 16, wherein the one or more social signals include one or more of: comments or sentiment reactions.

20. The non-transitory computer readable medium of claim 16, wherein the method further comprises training a second machine learning model based on social signals associated with a plurality of content items, and wherein the determining the subsequent classification for the content item is based on the second machine learning model.
